(19) United States
(12) Patent Application Publication
(10) Pub. No.: US 2005/0274060 A1
(43) Pub. Date: Dec. 15, 2005

(54) Removable insect barrier for substantially preventing entrance of insects through an opening of a vehicle or other enclosure

(76) Inventors: Matthew E. Lederle, Boulder, CO (US); Christopher W. Kennerly, Richardson, TX (US)

Correspondence Address: BAKER BOTTS L.L.P., 2001 ROSS AVENUE, SUITE 600, DALLAS, TX, 75201-2980, US

(21) Appl. No.: 10/856,293

(22) Filed: May 27, 2004

(51) Int. Cl. A01M 1/24

(52) U.S. Cl. 43/132.1; 43/119

(57) ABSTRACT

According to one embodiment, a removable insect barrier substantially prevents entrance of insects through an opening of a vehicle or other enclosure in which persons may be located. A perimeter of a magnetic layer removably couples to the enclosure substantially surrounding the opening to substantially prevent entrance of insects between the magnetic layer and the enclosure. A screen coupled to the perimeter of the magnetic layer substantially covers the opening and allows air to flow through the screen while substantially preventing entrance of insects through the screen. According to another embodiment, a removable insect barrier substantially prevents entrance of insects through an opening of a vehicle or other enclosure in which one or more persons may be located. A perimeter of a flexible layer substantially surrounds the opening. Attachment devices coupled to the perimeter of the flexible layer removably couple to the enclosure at locations about the opening. A screen coupled to the perimeter of the flexible layer substantially covers the opening and allows air to flow through the screen while substantially preventing entrance of insects through the screen. The flexible layer allows the location of an attachment device about the opening to be adjusted relative to the locations of other attachment devices about the opening.

### TECHNICAL FIELD

This invention relates generally to insect barriers, and more particularly to a removable insect barrier for substantially preventing entrance of insects through an opening of a vehicle or other enclosure.

### BACKGROUND

People regularly spend time in insect-infested regions. It is commonplace for outdoors enthusiasts to sleep or spend extended periods of time in their vehicles or other enclosures. For example, many people choose to sleep in their vehicles when camping in bear country, when arriving to their campsites at night or during rainy weather, or when they do not have a tent or simply prefer not to set up a tent. If the weather is warm, it is often not comfortable to keep the vehicle windows up, nor is it economical to keep the vehicle air-conditioning system running for long periods in a resting vehicle. Conversely, if the windows are down, there is often no way to keep insects from entering the vehicle. In addition to the annoyance and discomfort often associated with insects and insect bites, insects and insect bites have been linked to serious health problems (e.g., transmission of West Nile virus, Lyme disease, and other illnesses). Although people commonly resort to insect repellants for relief, some insect repellants may be unpleasant, noxious, or impractical, such as for use with infants. As a result of these or other disadvantages and problems, previous solutions for battling insects may be inadequate to meet certain needs.

### SUMMARY OF THE INVENTION

In accordance with the present invention, certain disadvantages and problems associated with previous insect barriers may be reduced or eliminated.

According to one embodiment, a removable insect barrier is provided for substantially preventing entrance of insects through an opening of a vehicle or other enclosure in which one or more persons may be located. The barrier includes a magnetic layer having a perimeter adapted to removably couple to a surface of the enclosure substantially surrounding the opening to substantially prevent entrance of insects between the magnetic layer and the surface of the enclosure. The barrier also includes a screen coupled to the perimeter of the magnetic layer, the screen adapted to substantially cover the opening and to allow air to flow through the screen while substantially preventing entrance of insects through the screen.

According to another embodiment, a removable insect barrier is provided for substantially preventing entrance of insects through an opening of a vehicle or other enclosure in which one or more persons may be located. The barrier includes a flexible layer having a perimeter adapted to substantially surround the opening. The barrier includes a number of attachment devices coupled to the perimeter of the flexible layer and adapted to removably couple to a surface of the enclosure at a plurality of locations about the opening. The barrier also includes a screen coupled to the perimeter of the flexible layer, the screen adapted to substantially cover the opening and to allow air to flow through the screen while substantially preventing entrance of insects through the screen. The flexible layer is adapted to allow the location of an attachment device about the opening to be adjusted relative to the locations of other attachment devices about the opening.

Particular embodiments of the present invention may provide one or more important technical advantages. For example, certain embodiments provide an insect barrier that substantially prevents entrance of insects through a window or other opening of a vehicle or other enclosure, while allowing outside air to flow through the opening. Certain embodiments allow the user to attach the barrier to a portion of the vehicle or other enclosure surrounding an opening using one or more magnets, suction cups, or other attachment devices located about a perimeter of the barrier. In certain embodiments, the perimeter of the barrier may be substantially fixed in size and shape, such as where the barrier is to be used with a window particular opening (e.g., a right rear window opening) of a particular make and model of vehicle (e.g., Chevrolet® Tahoe®), a particular make and class of vehicles (e.g., Chevrolet® sports utility vehicles (SUVs)), or a particular class of vehicles (e.g., SUVs), for which the particular window opening has substantially the same size and shape. In certain embodiments, the perimeter of the barrier may be substantially adjustable in size and shape, such as where the barrier is intended to be used with any of multiple window openings for any of multiple makes and models of vehicles, for which the window openings may vary in size and shape. For example, where multiple magnets, suction cups, or other attachment devices are provided about the perimeter of the barrier, the multiple attachment devices may be repositioned about the opening as appropriate to achieve optimal fit and performance. In certain embodiments, whether the perimeter of the barrier is fixed or adjustable in size and shape, the barrier may be provided in a number of different sizes to improve fit and performance. In certain embodiments, the barrier may be quickly and easily applied to the vehicle or other enclosure, quickly and easily removed from the vehicle for travel and storage, and quickly and easily reapplied to the vehicle or other enclosure as needed. In certain embodiments, the barrier may be stored in a sleeve or other portable container to keep the barrier substantially free of dirt, oil, or other contaminants that might decrease its ability to attach to the surface of the vehicle or other enclosure. In certain embodiments, particularly where the perimeter of the barrier is adjustable in size and shape, the barrier may be rolled up, folded, or otherwise compressed for convenient storage in a flexible pouch or other portable container. In certain embodiments, a removable awning may be provided for use together with or separate from a removable barrier as described above. The awning may be adapted for attachment to a vehicle or other enclosure over a window or other opening using one or more attachment devices, such as one or more magnets, to help prevent rain, debris, or other materials from entering the opening or contacting the barrier.

Certain embodiments may provide all, some, or none of these advantages. Certain embodiments may provide one or more other advantages, one or more of which may be apparent to those skilled in the art from the figures, descriptions, and claims included herein.

### BRIEF DESCRIPTION OF THE DRAWINGS

For a more complete understanding of the present invention and certain features and advantages thereof, reference is now made to the following description taken in conjunction with the accompanying drawings, in which:

FIGS. 1A-1B illustrate an example removable insect barrier adapted for substantially preventing entrance of insects through a window or other opening of a vehicle or other enclosure, where the perimeter of the barrier attaching to the vehicle or other enclosure is substantially fixed in size and shape;

FIG. 2 illustrates an exploded view of the example barrier of FIGS. 1A-1B;

FIG. 3 illustrates a cross-sectional view of the perimeter of the example barrier of FIGS. 1A-1B;

FIG. 4 illustrates an example method of attaching and removing the example barrier of FIGS. 1A-1B;

FIGS. 5A-5B illustrate an example removable insect barrier adapted for substantially preventing entrance of insects through a window or other opening of a vehicle or other enclosure, where the perimeter of the barrier attaching to the vehicle or other enclosure is adjustable in size and shape;

FIG. 6 illustrates an exploded view of the example barrier of FIGS. 5A-5B;

FIG. 7 illustrates a cross-sectional view of the perimeter of the example barrier of FIGS. 4A-4B;

FIGS. 8A-8D illustrate example attachment devices coupled to the bottom surface of an interior layer of the example barrier of FIGS. 4A-4B;

FIGS. 9A-9D illustrate example attachment devices coupled to the bottom surface of an exterior layer of the example barrier of FIGS. 4A-4B;

FIGS. 10A-10B illustrate side views of the perimeter of the example barrier of FIGS. 5A-5B, including complementary hook and loop fabric portions between adjacent attachment devices;

FIGS. 11A-11B illustrate the example barrier of FIGS. 5A-5B with an example rolled fabric edge;

FIG. 12 illustrates an example method of attaching and removing the example barrier of FIGS. 5A-5B;

FIG. 13 illustrates an example removable awning for attachment over a window or other opening of a vehicle or other enclosure; and

FIGS. 14A-14C illustrate example attachment devices for attaching the awning of FIG. 13 to a vehicle or other enclosure.

### DESCRIPTION OF EXAMPLE EMBODIMENTS

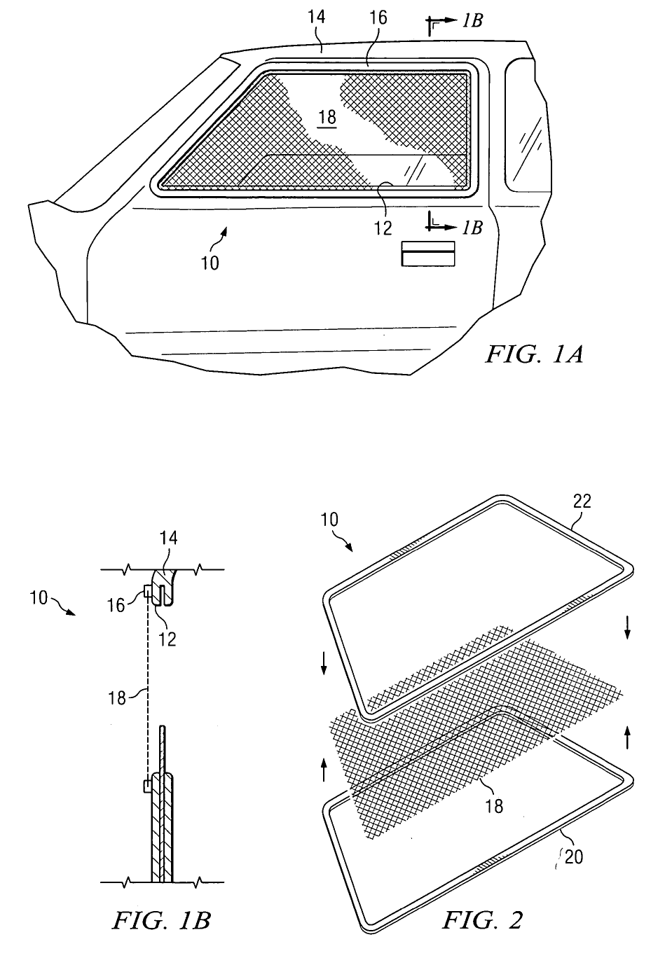

FIGS. 1A-1B illustrate an example removable insect barrier 10 adapted for substantially preventing entrance of insects through a window or other opening 12 of a vehicle or other enclosure 14, where the perimeter 16 of barrier 10 attaching to the vehicle or other enclosure 14 is substantially fixed in size and shape. Barrier 10 includes a flexible screen 18 that substantially prevents entrance of insects into opening 12 when barrier 10 is properly attached to the vehicle or other enclosure 14. Screen 18 may be constructed of any suitable material known in the art for such purposes, such as nylon, vinyl, fiberglass, rubber, metal, or any other suitable material. In certain embodiments, perimeter 16 of barrier 10 is magnetically attached to the exterior metal surface of the vehicle or other enclosure 14 about opening 12, thereby substantially preventing insects from entering opening 12. In certain embodiments, perimeter 16 is adapted in size and shape to optimally fit a particular window opening 12 (e.g., a right rear window opening) of a particular make and model of vehicle 14 (e.g., Chevrolet® Tahoe®), a particular make and class of vehicles 14 (e.g., Chevrolet® SUVs), or a particular class of vehicles 14 (e.g., SUVs) regardless of make and model. Preferably, perimeter 16 of barrier 10 is sufficiently flexible to conform to the exterior surface of the vehicle or other enclosure 14 to provide a substantially insect-proof seal against the exterior surface of the vehicle or other enclosure 14.

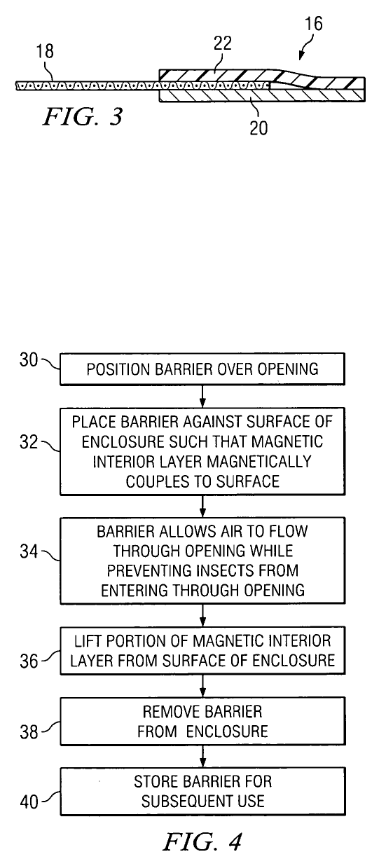

FIG. 2 illustrates an exploded view of example barrier 10 of FIGS. 1A-1B. FIG. 3 illustrates a cross-sectional view of the perimeter of example barrier 10 of FIGS. 1A-1B. In certain embodiments, as illustrated in FIGS. 2-3, screen 18 of barrier 10 may be coupled between a magnetic interior layer 20 and a non-magnetic exterior layer 22 about the perimeter 16 of barrier 10. Any suitable magnetic material may be used to form interior layer 20. Any suitable plastic, rubber, fabric, or other non-magnetic material may be used to form exterior layer 22. Layers 20 and 22 may be coupled to one another along their edges adhesively (e.g., using a glue or another suitable adhesive agent), mechanically (e.g., using rivets, staples, stitches, or other suitable mechanical agents), or in any other appropriate manner. Preferably, layers 20 and 22 are coupled to one another along perimeter 16 in such a way that screen 18 is securely coupled between layers 20 and 22 and does not become detached despite repeated attachment to the vehicle or other enclosure 14, use, and removal from the vehicle or other enclosure 14. Although two layers 20 and 22 are primarily described, the present invention contemplates barrier 10 having any suitable number of layers according to particular needs. For example, screen 18 may simply be glued or otherwise coupled along its edge to a single interior layer 20 to form barrier 10.

In particular embodiments, interior layer 20 may be formed from the same or similar materials as, and may be formed in the same or a similar manner as, flexible sheet magnets commonly used to removably attach photographs, notes, or other items to refrigerators and other metal appliances. For example, in one method used to form such flexible sheet magnets, a dry mixture of ferrite powder and rubber polymer resin is mixed, calendered, and ground. A flexible sheet is then formed from the mixture, for example, using a rolling process. The flexible sheet is then magnetized, laminated with vinyl or another material, cut to the appropriate size and shape, and rolled onto an appropriate core. In particular embodiments, exterior layer 22 may include a thin plastic, rubber, or other coating material that is applied in liquid form, surrounds the individual fibers of screen 18, and adheres to interior layer 20 to securely couple screen to interior layer 20 once the coating material has hardened or otherwise assumed a non-liquid form.

FIG. 4 illustrates an example method of attaching and removing the example barrier 10 of FIGS. 1A-1B. At step 30, for attachment, barrier 10 is positioned over a window or other opening 12 of a vehicle or other enclosure 14. At step 32, perimeter 16 of barrier 10 is placed against the exterior surface of the vehicle or other enclosure 14 such that interior layer 20 magnetically couples to the exterior surface. At step 34, during use, barrier 10 allows air to flow into and out of opening 12 while substantially preventing insects from entering through opening 12. At step 36, for removal, a portion of perimeter 16 of barrier 10 is lifted from the exterior surface of the vehicle or other enclosure 14 using the fingers or otherwise. At step 38, barrier 10 is removed from the exterior surface of the vehicle or other enclosure 14. At step 40, barrier 10 may be stored for travel and subsequent use, preferably in a sleeve or other portable container that keeps barrier 10 substantially free of dirt, oil, or other contaminants that might decrease the ability of interior layer 20 to attach to the exterior surface of the vehicle or other enclosure 14.

Although barrier 10 is primarily described as attaching to the exterior surface of a vehicle or other enclosure 14 about opening 12, the present invention contemplates barrier 10 being attached to the interior surface of the vehicle or other enclosure 14 about opening 12 where appropriate. For example, where the exterior of the vehicle or other enclosure 14 about opening 12 is too irregular to allow for an adequate seal between barrier 10 and the exterior surface, due to a rear-view mirror, trim element, or otherwise, it may be desirable to instead attach barrier 10 to the interior surface of the vehicle or other enclosure 14 about opening 12.

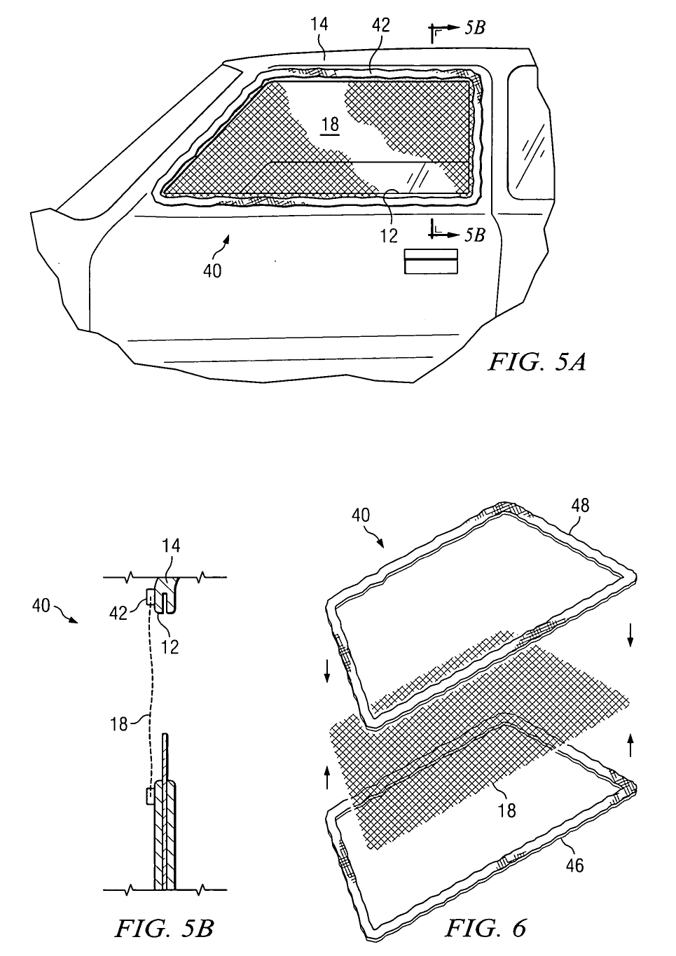

FIGS. 5A-5B illustrate an example removable insect barrier 40 adapted for substantially preventing entrance of insects through a window or other opening 12 of a vehicle or other enclosure 14, where the perimeter 42 of barrier 40 attaching to the vehicle or other enclosure 14 is adjustable in size and shape. Barrier 40 includes a flexible screen 18 as described above with reference to FIGS. 1A-1B. In certain embodiment, it may be preferable to use a flexible insect netting material for screen 18 to improve the adjustability of barrier 40 as discussed more fully below. In certain embodiments, perimeter 42 of barrier 40 is attached to the exterior surface of the vehicle or other enclosure 14 about opening 12, thereby substantially preventing insects from entering opening 12. In particular embodiments, any number of magnets, suction cups, or other attachment devices 44 are provided about perimeter 42 and may be repositioned relative to one another about opening 12 as appropriate to achieve optimal fit and performance. For example, magnets may be used if the exterior surface of the vehicle or other enclosure 14 is metal, whereas suction cups may be used if the exterior surface of the vehicle or other enclosure 14 is fiberglass. In certain embodiments, perimeter 42 is substantially adjustable in size and shape for use with any of multiple window openings 12 for any of multiple makes and models of vehicles 14, for which the window openings 12 may vary in size and shape. Preferably, perimeter 42 of barrier 10 is sufficiently flexible to conform to the exterior surface of the vehicle or other enclosure 14 to provide a substantially insect-proof seal against the exterior surface of the vehicle or other enclosure 14.

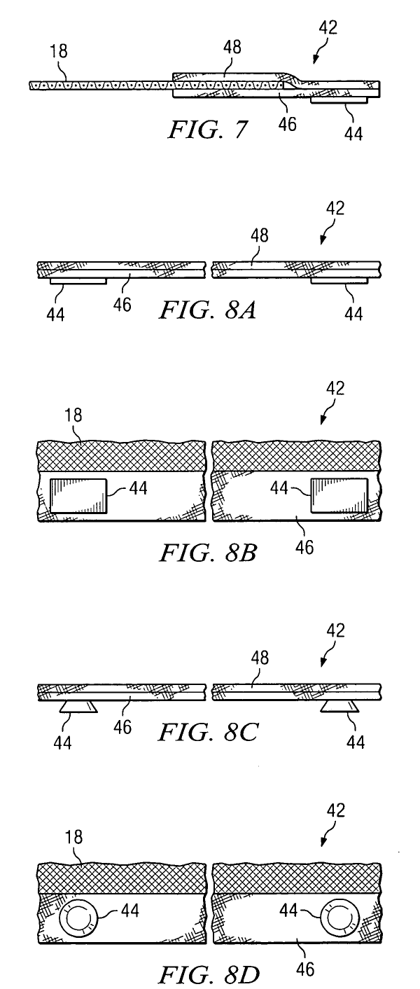

FIG. 6 illustrates an exploded view of example barrier 40 of FIGS. 5A-5B. FIG. 7 illustrates a cross-sectional view of the perimeter of example barrier 40 of FIGS. 5A-5B. In certain embodiments, as illustrated in FIGS. 6-7, screen 18 of barrier 40 may be coupled between an interior layer 46 and an exterior layer 48 about the perimeter 42 of barrier 40. Any suitable plastic, rubber, fabric, or other material may be used to form layers 46 and 48. Layers 46 and 48 may be coupled to one another along their edges adhesively (e.g., using a glue or another suitable adhesive agent), mechanically (e.g., using rivets, staples, stitches, or other suitable mechanical agents), or in any other suitable manner. As another example, an appropriately shaped plastic, rubber, fabric, or other structure may be folded or rolled upon itself to form opposing layers 46 and 48, with screen 18 being coupled between opposing layers 46 and 48 to form barrier 40. Like layers 20 and 22 described above with reference to FIGS. 2-3, layers 46 and 48 are preferably coupled to one another along perimeter 42 in such a way that screen 18 is securely coupled between layers 46 and 48 and does not become detached despite repeated attachment to the vehicle or other enclosure 14, use, and removal from the vehicle or other enclosure 14. Although two layers 46 and 48 are primarily described, the present invention contemplates barrier 40 having any suitable number of layers. For example, screen 18 may simply be glued or otherwise coupled along its edge to a single interior layer 46 to form barrier 40.

As described above, multiple magnets, suction cups, or other attachment devices 44 may be provided about perimeter 42. In certain embodiments, the bottom surface of interior layer 46 to be placed in contact with the exterior surface of the vehicle or other enclosure 14 may be substantially continuous, attachment devices 44 may be adhesively, mechanically, or otherwise coupled to the bottom surface of interior layer 46 at selected locations, and the exposed bottom surfaces of attachment devices 44 may be used to attach barrier 40 to the exterior surface of the vehicle or other enclosure 14. For example, as shown in FIGS. 8A-8B, for attachment to a metal surface of a vehicle or other enclosure 14, any number of circular, rectangular, or other magnets may be used as attachment devices 44. Such magnets may be flexible sheet magnets as described above with reference to FIGS. 2-3 or any other suitable magnets. As another example, as shown in FIGS. 8C-8D, for attachment to a fiberglass or other non-metal surface of a vehicle or other enclosure 14, any number of circular, rectangular, or other suction cups may be used as attachment devices 44. In any of these example embodiments, depending on the size and shape of attachment devices 44, portions of attachment devices 44 may extend through interior layer 46, exterior layer 48, or both.

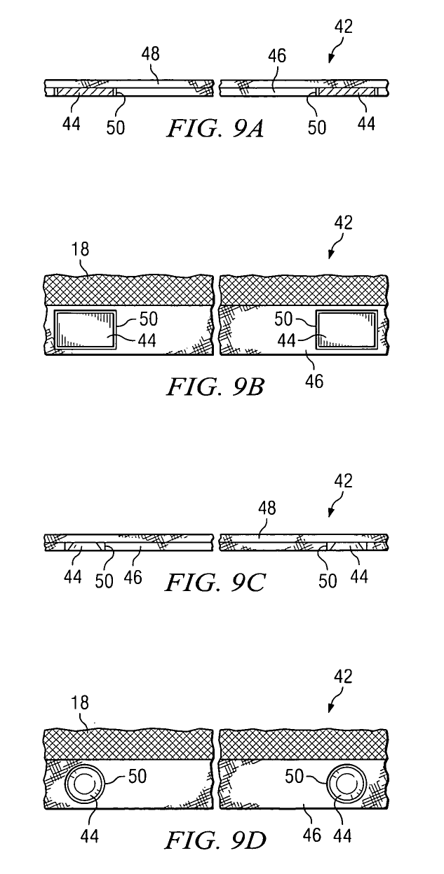

In certain other embodiments, attachment devices 44 may be adhesively, mechanically, or otherwise coupled to the bottom surface of exterior layer 48 at selected locations, the bottom surface of interior layer 46 to be placed in contact with the exterior surface of the vehicle or other enclosure 14 may be discontinuous such that an opening 50 is provided for each attachment device 44, and the exposed bottom surfaces of attachment devices 44 may be used to attach barrier 40 to the exterior surface of the vehicle or other enclosure 14. For example, as shown in FIGS. 9A-9B, for attachment to a metal surface of a vehicle or other enclosure 14, any number of circular, rectangular, or other magnets may be used as attachment devices 44. Such magnets may be flexible sheet magnets as described above with reference to FIGS. 2-3 or any other suitable magnets. As another example, as shown in FIGS. 9C-9D, for attachment to a fiberglass or other non-metal surface of a vehicle or other enclosure 14, any number of circular, rectangular, or other suction cups may be used as attachment devices 44. In any of these example embodiments, depending on the size and shape of attachment devices 44, portions of attachment devices 44 may extend through exterior layer 48.

Although example embodiments in which attachment devices 44 are coupled to the bottom surface of interior layer 46 or the bottom surface of exterior layer 48, the present invention contemplates coupling attachment devices 44 to perimeter 42 of barrier 40 in any suitable manner according to particular needs.

Preferably, attachment devices 44 are spaced sufficiently close to one another that a substantially insect-proof seal may be formed against the exterior surface of the vehicle or other enclosure 14. Preferably, attachment devices 44 are also spaced sufficiently far apart from one another that a substantial amount of adjustability is provided in order to substantially optimally confirm perimeter 42 of barrier 40 to a particular window opening 12 of a particular vehicle or other enclosure 14. For example, barrier 40 may initially have a generally rectangularly shaped perimeter 42 that is large enough to surround almost any front or rear window opening 12 of almost any make and model of SUV 14. For a particular window opening 12 of a particular SUV 14, the user may attach barrier 40 over window opening 12 and adjust the relative positions of attachment devices 44 about window opening 12 to achieve optimal fit and performance. In certain embodiments, perimeter 42 is substantially adjustable in size and shape for use with any of multiple window openings 12 for any of multiple makes and models of vehicles 14, for which the window openings 12 may vary in size and shape.

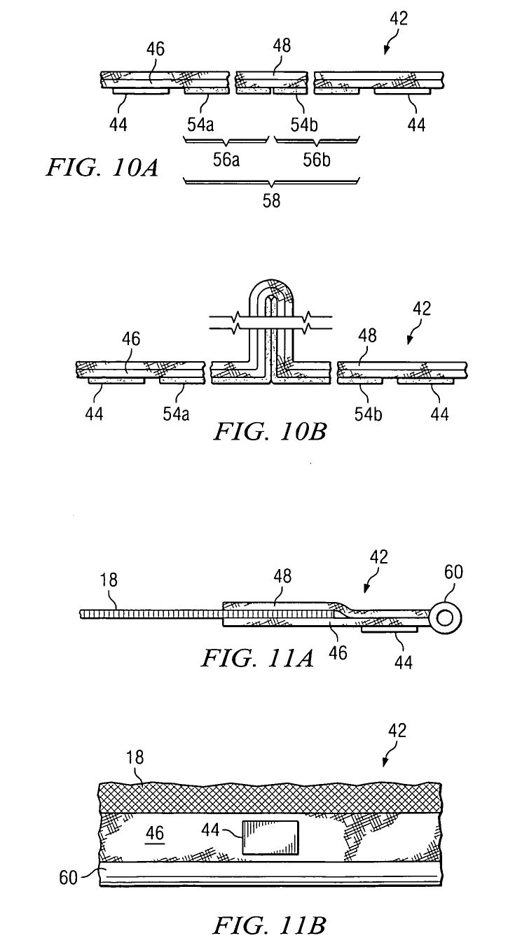

In certain embodiments, as illustrated in FIGS. 10A-10B, to help improve the effectiveness of barrier 40 in preventing entrance of insects, barrier 40 may include Velcro® or other suitable hook and loop fabric 54 about perimeter 42 of barrier 40 between attachment devices 44. In these embodiments, where portions of perimeter 42 are not in sufficient contact with the exterior surface of the vehicle or other enclosure 14 due to the repositioning of attachment devices 44, opposing portions of hook and loop fabric 54 along such portions of perimeter 42 may be coupled to one another to help make barrier 40 more insect-proof. In particular embodiments, a first portion 54a of hook and loop fabric 54 (either hook or loop) is located along a first half 56a of a segment 58 of perimeter 42 between adjacent attachment devices 44, and a second portion 54b of hook and loop fabric 54 (either loop or hook, respectively) is located along a second half 56b of segment 58 of perimeter 42 between adjacent attachment devices 44. If any portion of segment 58 of perimeter 42 is not in sufficient contact with the exterior surface of the vehicle or other enclosure 14 due to the repositioning of attachment devices 44, all or an appropriate portion of first portion 54a may be coupled to all or an appropriate portion of opposing second portion 54b to help make barrier 40 more insect-proof. Although hook and loop fabric 54 is primarily described as a mechanism to couple opposing portions of perimeter 42 to one another between attachment devices 44, the present invention contemplates snaps, buttons, or any other suitable mechanism to replace or combine with hook and loop fabric 54.

In certain embodiments, as illustrated in FIGS. 11A-11B, to help improve the effectiveness of barrier 40 in preventing entrance of insects, barrier 40 may include a rolled fabric edge 60. Rolled fabric edge 60 may be located about the entire perimeter 42 of barrier 40, may be located only between attachment devices 44, may be located only adjacent attachment devices 44, or may be used in any other suitable manner to help make barrier 40 more insect-proof.

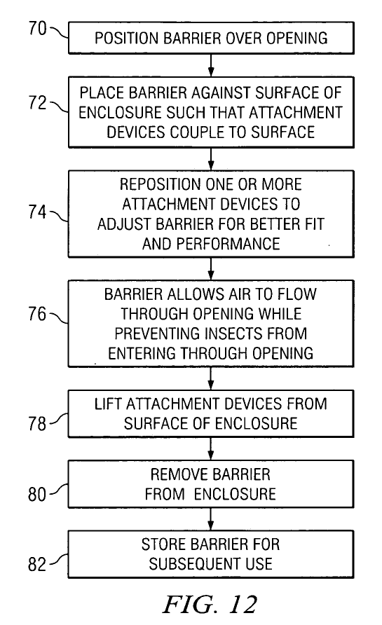

FIG. 12 illustrates an example method of attaching and removing the example barrier 10 of FIGS. 5A-5B. At step 70, for attachment, barrier 40 is positioned over a window or other opening 12 of a vehicle or other enclosure 14. At step 72, perimeter 42 of barrier 40 is placed against the exterior surface of the vehicle or other enclosure 14 such that attachment devices 44 couple to the exterior surface. At step 74, one or more attachment devices 44 may be repositioned to adjust barrier 40 for optimal fit and performance. At step 76, during use, barrier 40 allows air to flow into and out of opening 12 while substantially preventing insects from entering through opening 12. At step 78, for removal, attachment devices 44 are lifted from the exterior surface of the vehicle or other enclosure 14 using the fingers or otherwise. At step 80, barrier 40 is removed from the exterior surface of the vehicle or other enclosure 14. At step 82, barrier 40 may be stored for travel and subsequent use, preferably in a container that keeps barrier 40 substantially free of dirt, oil, or other contaminants that might decrease the ability of attachment devices 44 to attach to the exterior surface of the vehicle or other enclosure 14. In certain embodiments, barrier 40 may be rolled up, folded, or otherwise compressed for convenient storage in a flexible pouch or other portable container.

Although barrier 40 is primarily described as attaching to the exterior surface of a vehicle or other enclosure 14 about opening 12, the present invention contemplates barrier 40 being attached to the interior surface of the vehicle or other enclosure 14 about opening 12 where appropriate. For example, where the exterior of the vehicle or other enclosure 14 about opening 12 is too irregular to allow for an adequate seal between barrier 10 and the exterior surface, due to a rear-view mirror, trim element, or otherwise, despite the adjustability of barrier 40, it may be desirable to instead attach barrier 40 to the interior surface of the vehicle or other enclosure 14 about opening 12.

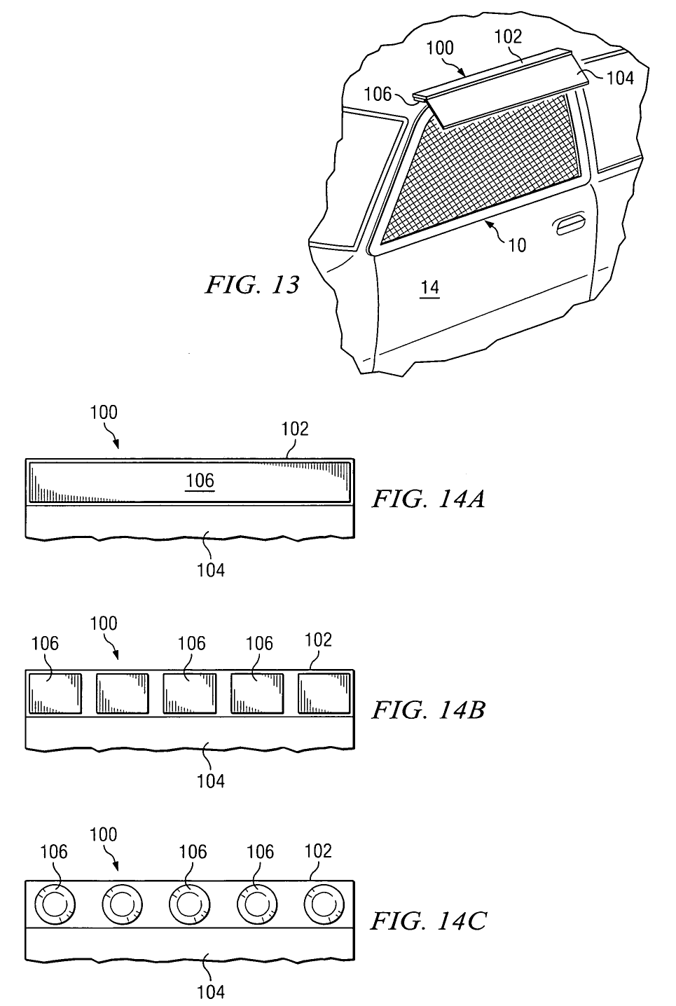

FIG. 13 illustrates an example removable awning 100 for attachment over a window or other opening 12 of a vehicle or other enclosure 14. Although shown in use with barrier 10 of FIGS. 1A-1B, awning 100 may be used together with or separate from the example barriers 10, 40 described above. Awning 100 includes an elongated body 102 and an elongated flap 104 extending from body 102 along its length. When attached to the vehicle or other enclosure 14, flap 104 is adapted to help prevent rain, debris, or other materials from entering through opening 12 or from contacting barrier 10, 40. Body 102 and flap 104 may each be formed from any suitable material, but are preferably formed from a lightweight plastic material. Body 102 and flap 104 may be integrally formed or may be separate components coupled to one another in any suitable manner.

Awning 100 includes one or more attachment devices 106 located along the bottom surface of body 102 and adapted for removably attaching awning 100 to the vehicle or other enclosure 14 over opening 12. For example, as shown in FIG. 14A, the one or more attachment devices 106 may include a single magnet or strip of magnetic material that extends along substantially the entire bottom surface of body 102 for attaching the awning 100 to a metal surface. As another example, as shown in FIG. 14B, the one or more attachment devices 106 may include a number of magnets or strips of magnetic material located at appropriate distances from one another along the bottom surface of body 102 for attaching the awning 100 to a metal surface. As another example, as shown in FIG. 14C, the one or more attachment devices 106 may include a number of suction cups located at appropriate distances from one another along the bottom surface of body 102 for attaching the awning 100 to a fiberglass or other non-metal surface.

Particular embodiments of the present invention may provide one or more important technical advantages. For example, certain embodiments provide an insect barrier that substantially prevents entrance of insects through a window or other opening of a vehicle or other enclosure, while allowing outside air to flow through the opening. Certain embodiments allow the user to attach the barrier to a portion of the vehicle or other enclosure surrounding an opening using one or more magnets, suction cups, or other attachment devices located about a perimeter of the barrier. In certain embodiments, the perimeter of the barrier may be substantially fixed in size and shape, such as where the barrier is to be used with a window particular opening (e.g., a right rear window opening) of a particular make and model of vehicle (e.g., Chevrolet® Tahoe®), a particular make and class of vehicles (e.g., Chevrolet® sports utility vehicles (SUVs)), or a particular class of vehicles (e.g., SUVs), for which the particular window opening has substantially the same size and shape. In certain embodiments, the perimeter of the barrier may be substantially adjustable in size and shape, such as where the barrier is intended to be used with any of multiple window openings for any of multiple makes and models of vehicles, for which the window openings may vary in size and shape. For example, where multiple magnets, suction cups, or other attachment devices are provided about the perimeter of the barrier, the multiple attachment devices may be repositioned about the opening as appropriate to achieve optimal fit and performance. In certain embodiments, whether the perimeter of the barrier is fixed or adjustable in size and shape, the barrier may be provided in a number of different sizes to improve fit and performance. In certain embodiments, the barrier may be quickly and easily applied to the vehicle or other enclosure, quickly and easily removed from the vehicle for travel and storage, and quickly and easily reapplied to the vehicle or other enclosure as needed. In certain embodiments, the barrier may be stored in a sleeve or other portable container to keep the barrier substantially free of dirt, oil, or other contaminants that might decrease its ability to attach to the surface of the vehicle or other enclosure. In certain embodiments, particularly where the perimeter of the barrier is adjustable in size and shape, the barrier may be rolled up, folded, or otherwise compressed for convenient storage in a flexible pouch or other portable container. In certain embodiments, a removable awning may be provided for use together with or separate from a removable barrier as described above. The awning may be adapted for attachment to a vehicle or other enclosure over a window or other opening using one or more attachment devices, such as one or more magnets, to help prevent rain, debris, or other materials from entering the opening or contacting the barrier.

Although the present invention has been described above in connection with several embodiments, a plethora of changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

1. A removable insect barrier for substantially preventing entrance of insects through an opening of an enclosure in which one or more persons may be located, comprising:
a magnetic layer having a perimeter adapted to removably couple to a surface of the enclosure substantially surrounding the opening to substantially prevent entrance of insects between the magnetic layer and the surface of the enclosure; and
a screen coupled to the perimeter of the magnetic layer, the screen adapted to substantially cover the opening and to allow air to flow through the screen while substantially preventing entrance of insects through the screen.

2. The barrier of claim 1, wherein the perimeter of the magnetic layer comprises a flexible magnetic material adapted to conform to the surface of the enclosure substantially surrounding the opening.

3. The barrier of claim 1, wherein the perimeter of the magnetic layer comprises a flexible refrigerator magnet material.

4. The barrier of claim 1, wherein the enclosure is a vehicle and the opening is a window opening of the vehicle.

5. The barrier of claim 4, wherein the perimeter of the magnetic layer is adapted in size and shape to optimally fit a particular window of one or more of:
a particular class of vehicles;
a particular make and class of vehicle; and
a particular make and model of vehicle.

6. The barrier of claim 1, wherein:
the barrier further comprises a non-magnetic layer having a perimeter coupled to the perimeter of the magnetic layer; and
the screen is coupled between the perimeters of the magnetic and non-magnetic layers.

7. A method of substantially preventing entrance of insects through an opening of an enclosure in which one or more persons may be located, comprising:
removably coupling a perimeter of an insect barrier to a surface of the enclosure substantially surrounding the opening, the barrier comprising:
a magnetic layer having a perimeter adapted to removably couple to the surface of the enclosure substantially surrounding the opening to substantially prevent entrance of insects between the magnetic layer and the surface of the enclosure; and
a screen coupled to the perimeter of the magnetic layer, the screen adapted to substantially cover the opening and to allow air to flow through the screen while substantially preventing entrance of insects through the screen; and
allowing air to flow through the screen while substantially preventing entrance of insects through the screen.

8. The method of claim 7, wherein the perimeter of the magnetic layer comprises a flexible magnetic material adapted to conform to the surface of the enclosure substantially surrounding the opening and the method comprises allowing the perimeter of the magnetic layer to conform to the surface of the enclosure substantially surrounding the opening.

9. The method of claim 7, wherein the perimeter of the magnetic layer comprises a flexible refrigerator magnet material.

10. The method of claim 7, wherein the enclosure is a vehicle and the opening is a window opening of the vehicle.

11. The method of claim 10, wherein the perimeter of the magnetic layer is adapted in size and shape to optimally fit a particular window of one or more of:
a particular class of vehicles;
a particular make and class of vehicle; and
a particular make and model of vehicle.

12. The method of claim 7, wherein:
the barrier further comprises a non-magnetic layer having a perimeter coupled to the perimeter of the magnetic layer; and
the screen is coupled between the perimeters of the magnetic and non-magnetic layers.

13. A removable insect barrier for substantially preventing entrance of insects through an opening of an enclosure in which one or more persons may be located, comprising:
a flexible layer having a perimeter adapted to substantially surround the opening;
a plurality of attachment devices coupled to the perimeter of the flexible layer and adapted to removably couple to a surface of the enclosure at a plurality of locations about the opening; and
a screen coupled to the perimeter of the flexible layer, the screen adapted to substantially cover the opening and to allow air to flow through the screen while substantially preventing entrance of insects through the screen;
the flexible layer being adapted to allow the location of an attachment device about the opening to be adjusted relative to the locations of other attachment devices about the opening.

14. The barrier of claim 13, wherein the flexible layer is adapted to conform to the surface of the enclosure substantially surrounding the opening.

15. The barrier of claim 13, wherein the attachment devices comprise magnets.

16. The barrier of claim 13, wherein the attachment devices comprise a flexible refrigerator magnet material.

17. The barrier of claim 13, wherein the attachment devices comprise suction cups.

18. The barrier of claim 13, wherein the enclosure is a vehicle and the opening is a window opening of the vehicle.

19. The barrier of claim 18, wherein the flexible layer is adapted to allow the locations of the attachment devices about the opening to be adjusted to fit the barrier to any of a plurality of vehicles.

20. The barrier of claim 13, wherein:
the barrier further comprises a second flexible layer having a perimeter coupled to the perimeter of the flexible layer; and
the screen is coupled between the perimeters of the flexible layers.

21. The barrier of claim 13, wherein:
the barrier further comprises a second flexible layer having a perimeter with a top surface coupled to a bottom surface of the perimeter of the flexible layer and having a plurality of openings each corresponding to an attachment device; and
the one or more attachment devices are coupled to the bottom surface of the perimeter of the flexible layer and are exposed via the corresponding opening in the second flexible layer.

22. The barrier of claim 13, further comprising hook and loop fabrics coupled to a segment of the perimeter of the flexible layer between at least one pair of adjacent attachment devices, hook fabric being coupled to a first half of the segment, loop fabric being coupled to a second half of the segment, the hook fabric adapted to removably couple to the loop fabric when the locations of the pair of adjacent attachment devices are adjusted toward one another to substantially prevent entrance of insects between the flexible layer and the surface of the enclosure between the pair of adjacent attachment devices.

23. The barrier of claim 13, further comprising a rolled fabric edge about the perimeter of the flexible layer.

24. A method of substantially preventing entrance of insects through an opening of an enclosure in which one or more persons may be located, comprising:
removably coupling a perimeter of an insect barrier to a surface of the enclosure substantially surrounding the opening, the barrier comprising:
a flexible layer having a perimeter adapted to substantially surround the opening;
a plurality of attachment devices coupled to the perimeter of the flexible layer and adapted to removably couple to a surface of the enclosure at a plurality of locations about the opening; and
a screen coupled to the perimeter of the flexible layer, the screen adapted to substantially cover the opening and to allow air to flow through the screen while substantially preventing entrance of insects through the screen;
the flexible layer being adapted to allow the location of an attachment device about the opening to be adjusted relative to the locations of other attachment devices about the opening;
adjusting the location of at least one attachment device about the opening relative to the locations of other attachment devices about the opening; and
allowing air to flow through the screen while substantially preventing entrance of insects through the screen.

25. The method of claim 24, wherein the flexible layer is adapted to conform to the surface of the enclosure substantially surrounding the opening and the method comprises allowing the perimeter of the magnetic layer to conform to the surface of the enclosure substantially surrounding the opening.

26. The method of claim 24, wherein the attachment devices comprise magnets.

27. The method of claim 24, wherein the attachment devices comprise a flexible refrigerator magnet material.

28. The method of claim 24, wherein the attachment devices comprise suction cups.

29. The method of claim 24, wherein the enclosure is a vehicle and the opening is a window opening of the vehicle.

30. The method of claim 29, wherein the flexible layer is adapted to allow the locations of the attachment devices about the opening to be adjusted to fit the barrier to any of a plurality of vehicles.

31. The method of claim 24, wherein:
the barrier further comprises a second flexible layer having a perimeter coupled to the perimeter of the flexible layer; and
the screen is coupled between the perimeters of the flexible layers.

32. The method of claim 24, wherein:
the barrier further comprises a second flexible layer having a perimeter with a top surface coupled to a bottom surface of the perimeter of the flexible layer and having a plurality of openings each corresponding to an attachment device; and
the one or more attachment devices are coupled to the bottom surface of the perimeter of the flexible layer and are exposed via the corresponding opening in the second flexible layer.

33. The method of claim 24, wherein:
the barrier further comprises hook and loop fabrics coupled to a segment of the perimeter of the flexible layer between at least one pair of adjacent attachment devices, hook fabric being coupled to a first half of the segment, loop fabric being coupled to a second half of the segment; and
the method further comprises removably coupling the hook fabric to the loop fabric when the locations of the pair of adjacent attachment devices are adjusted toward one another to substantially prevent entrance of insects between the flexible layer and the surface of the enclosure between the pair of adjacent attachment devices.

34. The method of claim 24, wherein the barrier further comprises a rolled fabric edge about the perimeter of the flexible layer.
